(19) United States
(12) Patent Application Publication
(10) Pub. No.: US 2016/0349845 A1
(43) Pub. Date: Dec. 1, 2016

(54) Gesture Detection Haptics and Virtual Tools

(71) Applicant: Google Inc., Mountain View, CA (US)

(72) Inventors: Ivan Poupyrev, Sunnyvale, CA (US); Timo Arnall, London (GB); Carsten C. Schwesig, San Francisco, CA (US); Jack Schulze, London (GB)

(73) Assignee: Google Inc., Mountain View, CA (US)

(21) Appl. No.: 15/166,198

(22) Filed: May 26, 2016

Related U.S. Application Data
(60) Provisional application No. 62/167,792, filed on May 28, 2015.

(51) Int. Cl. G06F 3/01; G06F 3/0485; G06F 3/0484; G06F 3/0488; G06F 3/0481

(52) U.S. Cl. CPC G06F 3/016; G06F 3/017; G06F 3/04886; G06F 3/04815; G06F 3/04845; G06F 3/0485; G06F 3/04842

(57) ABSTRACT

Gesture detection haptics and virtual tools are described. In one example, movements are detected that involve contact in three-dimensional space, such as through use of radio waves, camera based techniques, and so forth. The contact provides haptic feedback to the user as part of making the movements. In another example, movements are detected that are used to both identify a virtual tool and a gesture that corresponds to the virtual tool. From these movements, gestures are identified that are used to initiate operations of a computing device.

### CROSS REFERENCE

This application claims priority to U.S. Provisional Patent Application No. 62/167,792, filed May 28, 2015, titled “Virtual Controls”, the entire disclosure of which is incorporated by reference.

### BACKGROUND

Gestures have been developed as a way to expand functionality available via computing devices in an intuitive manner. Gestures detected using touchscreen functionality of a computing device, for instance, may be used to mimic real world user interactions, such as to scroll through a webpage using a pan gesture, swipe to turn a page in a book, and so forth.

As the ways in which gestures may be detected has expanded, however, so too have the challenges in supporting interaction using these gestures. In one such example, techniques have been developed to recognize gestures in three dimensions, such that a user may perform actions that are recognized as a gesture without physically touching the computing device. Accordingly, conventional techniques to implement these gestures lack feedback and thus are not intuitive to users.

### SUMMARY

Gesture detection haptics and virtual tools are described. In one example, movements are detected that involve contact in three-dimensional space, such as through use of radio waves, camera based techniques, and so forth. The contact provides haptic feedback to the user as part of making the movements. In another example, movements are detected that are used to both identify a virtual tool and a gesture that corresponds to the virtual tool. From these movements, gestures are identified that are used to initiate operations of a computing device.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to perform gesture detection and interaction techniques described herein.

FIG. 2 is a flow diagram depicting a procedure in an example implementation in which inputs involving movement of body parts of a user that impart haptic feedback to the user are used to initiate operations of the computing device.

FIG. 3 depicts a system in an example implementation in which inputs involving movement of body parts of a user that impart haptic feedback to the user are used to initiate operations of the computing device

FIG. 4 depicts an example implementation of gesture detection haptics in which detection of contact is included as a basis of gesture recognition.

FIG. 5 depicts an example implementation of gesture detection haptics in which detection of contact is included as a basis of gesture recognition to define when a corresponding operation is to be initiated.

FIG. 6 depicts an example implementation of selection of an object in a user interface through use of the gesture of FIG. 5.

FIG. 7 depicts an example implementation in which additional examples of movements and contact to impart haptics are shown.

FIG. 8 depicts a system in an example implementation in which a gesture is detected through an article associated with or worn by a user.

FIG. 9 is a flow diagram depicting a procedure in an example implementation in which movements that mimic existence and control of a virtual tool are used to control operations of a computing device.

FIG. 10 depicts a system in which movements that mimic existence and control of a virtual tool are used to control operations of a computing device.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

Overview

Computing devices may be found in ever smaller configurations, such as from mobile phones to wearable devices. As part of this, however, it has become increasingly difficult to interact with these devices. One technique that has been developed to address this difficulty is to support user interactions (e.g., gestures) in three dimensional space that is proximal to the computing device, but does not involve actual contact with the computing device.

However, user interactions with a computing device in three-dimensional space may be challenging due to a lack of feedback. For example, a user may “wave a hand in the air” which is then detected by a camera of the computing device. Once detected, the computing device causes an operation to be performed that corresponds to the gesture, such as to navigate through a user interface. However, this user interaction is not intuitive due to a lack of physical feedback on the part of the user while making the gesture. For example, users in physical environments typically encounter feedback as part of interaction with this environment. Lack of such interaction may therefore feel unnatural to the users.

Accordingly, gesture detection haptic and virtual tool techniques are described. In one or more implementations, gestures are detected that involve movement of body parts of a user and that cause contact of those body parts, one to another. In this way, the contact provides haptic feedback to the user as part of the gesture. This overcomes the “lack of feel” of conventional gesture techniques and increases intuitiveness to a user that performs the gesture.

For example, a user may rub a forefinger and thumb together that mimics the winding of a watch. This movement may then be detected and recognized by a computing device and used to initiate an operation of the device of a corresponding gesture, such as to scroll through a user interface. Additionally, the contact between the thumb and forefinger provides feedback to the user and thus increases intuitiveness of performed of the gesture.

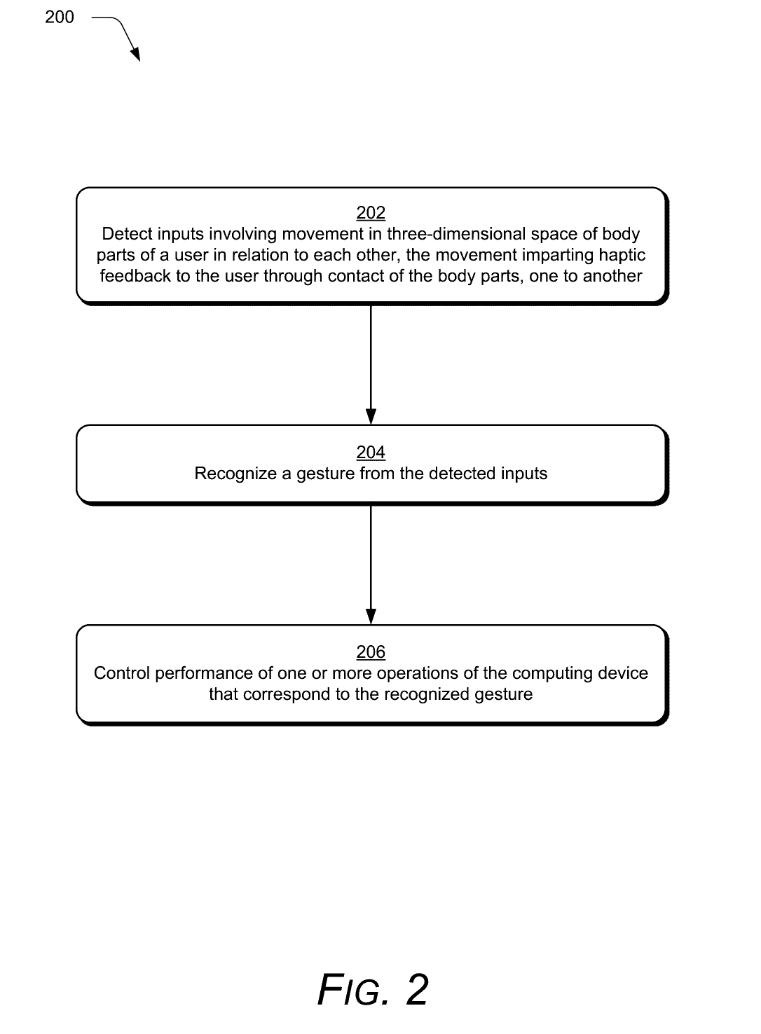

Further, the contact may be incorporated as a defining aspect of the gesture. For example, the contact of the pinch gesture above may be detected by the computing device as to when to initiate the gesture, e.g., to select an element in a user interface. As such, this contact is tied to the performance of the operation by the computing device and is felt by the user as part of the performance of the gesture. In this way, the contact of the movement of the body parts unites the user with the operation of the computing device. Further discussion of these and other examples are described in relation to FIGS. 2-8 in the following sections.

In another example, gesture detection techniques leverage use of virtual tools. In this way, a user is provided with a readily understood context in which to perform the gesture. For example, this context may define both a purpose of the gesture and how to perform the gesture. A computing device, for instance, may detect inputs involving user movement in three-dimensional space. From these detected movements, the computing device identifies both a virtual tool and recognizes a gesture as corresponding to this virtual tool. In one example, the user makes a motion with a hand that mimics grasping a virtual screwdriver and then rotation of the virtual screwdriver. The computing device then recognizes this mimicked grasping and rotational movement as corresponding to an operation to rotate an item in a user interface. Accordingly, the user is readily made aware as to availability of different gestures as well as how to perform those gestures to achieve a desired operation of the computing device.

A variety of other examples are also contemplated. In one example, a virtual button involves a mnemonic of an imaginary physical button attached to a fingertip. This virtual button can be “pressed,” for instance, by pressing thumb and index finger together. This may support use of a plurality of virtual buttons, e.g., where four buttons are attached to all fingers of one hand except the thumb. Therefore, individual “pressing” of these buttons may be recognized by a computing device to initiate different operations of the computing device.

In another example, a virtual trackpad involves a mnemonic of an imaginary trackpad that is operated through use of a thumb tapping and sliding, in two dimensions. This may be performed against the side of the index finger, against the inside of the hand, and so forth. This virtual tool can be mapped to visual interface events such as tapping and horizontal and vertical scrolling.

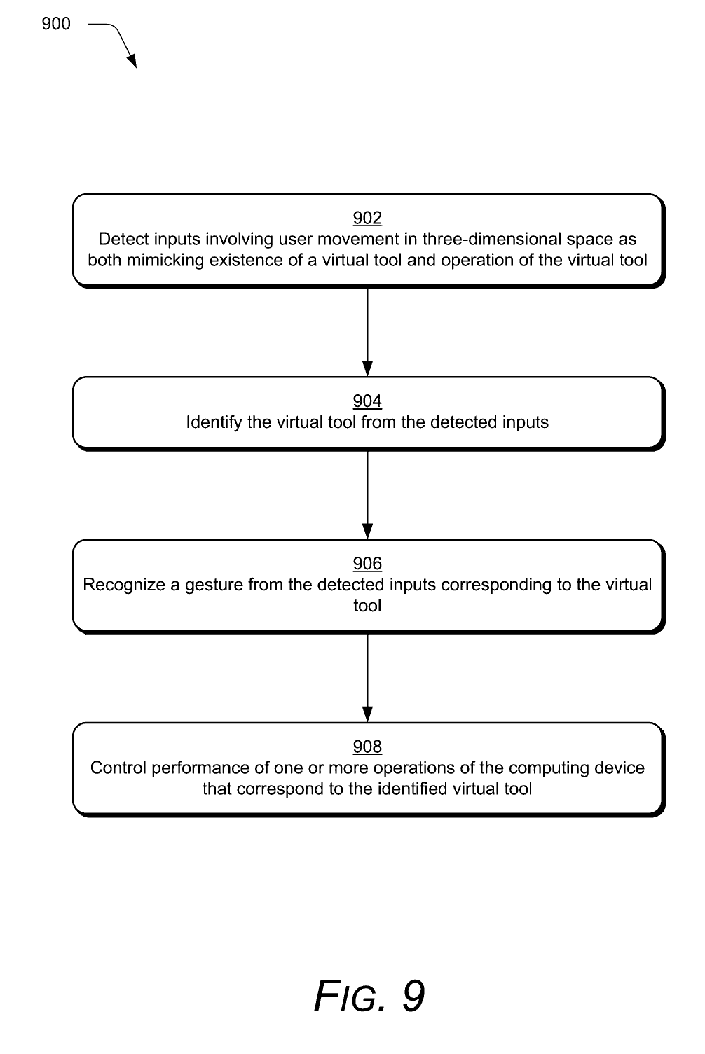

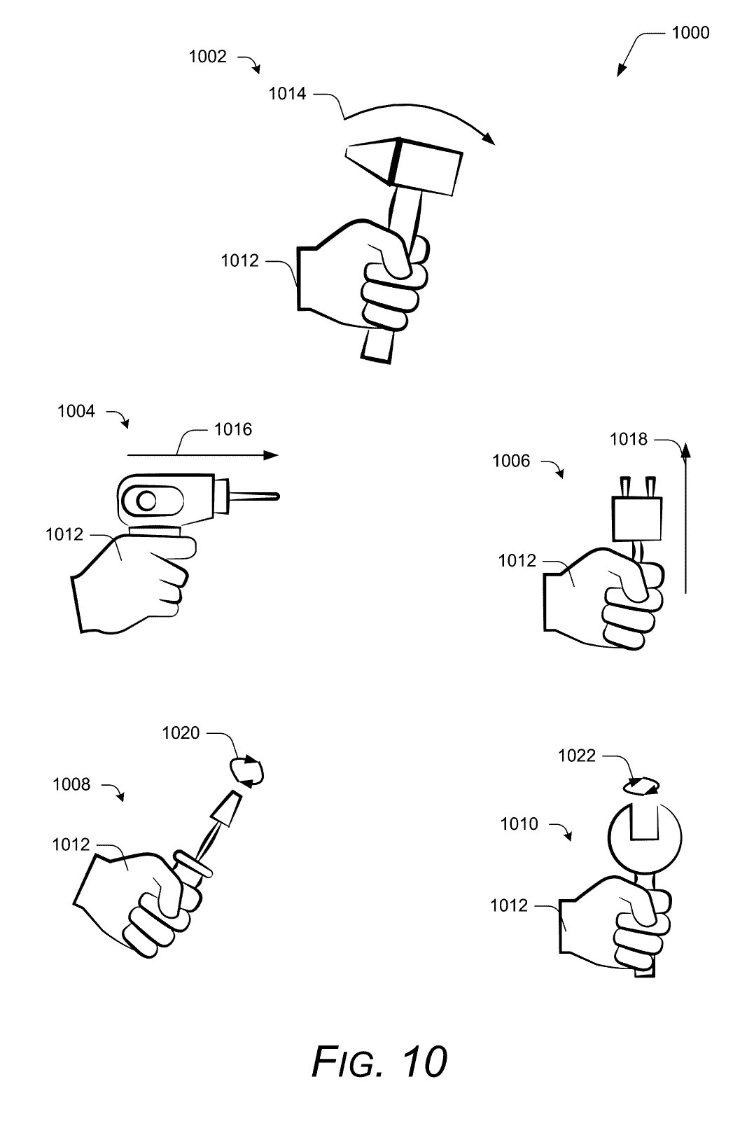

In a further example, a virtual dial involves a mnemonic of an imaginary dial situated between thumb and index finger. By rubbing the fingertips together, the dial is turned. This virtual tool can be mapped to range adjustments in the computing device, such as volume control. In yet another example, a virtual dial involves a mnemonic of an imaginary slider attached to the thumb-facing side of the index finger. It is operated by sliding the thumb against that side of the index finger. This virtual tool can be mapped to range adjustments in the computing device, such as volume control. Further discussion of this and other examples are described in the following in relation to FIGS. 9 and 10.

In the following discussion, an example environment is described that may employ the gesture techniques described herein. Example procedures are also described which may be performed in the example environment as well as other environments. Consequently, performance of the example procedures is not limited to the example environment and the example environment is not limited to performance of the example procedures.

Example Environment

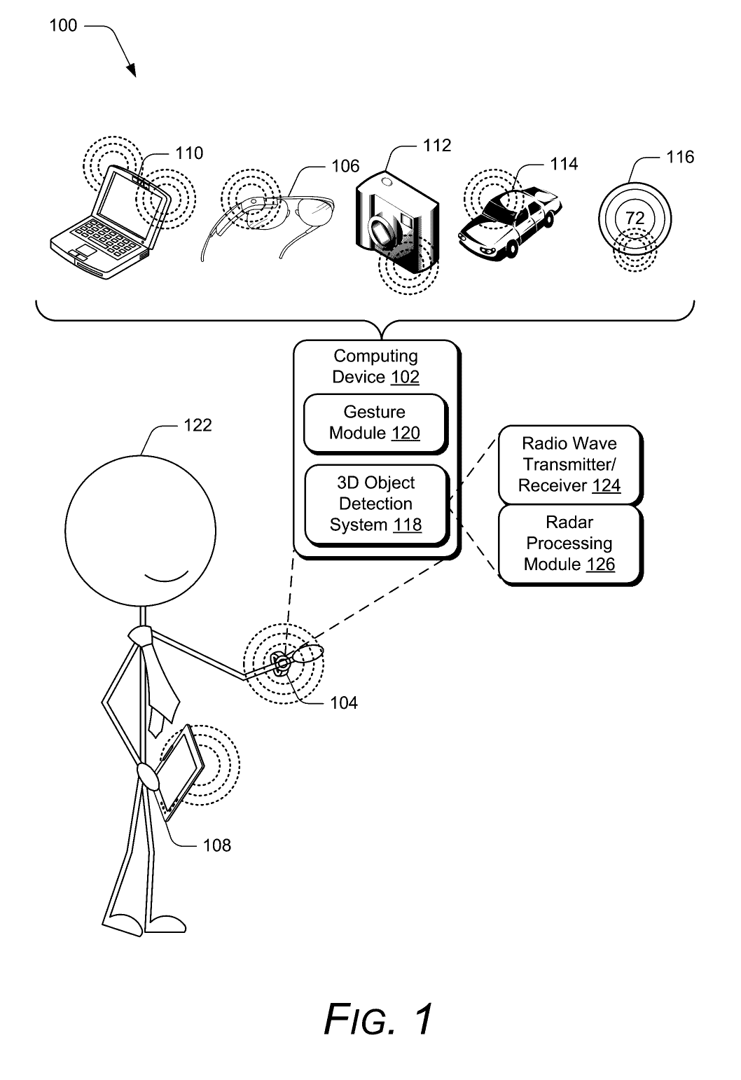

FIG. 1 is an illustration of an environment 100 in an example implementation that is operable to employ gesture detection haptic and virtual tool techniques described herein. The illustrated environment 100 includes a computing device 102, which is configurable in a variety of ways.

The computing device 102, for instance, may be configured as a wearable device having a housing 104 that is configured to be worn by or attached to a user. As such, the housing of the wearable device may take a variety of different forms, such as a ring, broach, pendant, configured to be worn on a wrist of a user as illustrated, glasses 106 as also illustrated, and so forth. The computing device 102 may also be configured to include a housing 108 configured to be held by one or more hands of a user, such as a mobile phone or tablet as illustrated, a laptop 110 computer, a dedicated camera 112, and so forth. Other examples include incorporation of the computing device 102 as part of a vehicle 114 (e.g., plane, train, boat, aircraft, and balloon), as part of the “Internet-of-things” such as a thermostat 116, appliance, vent, furnace, and so forth. Additional forms of computing devices 102 include desktop computers, game consoles, media consumption devices, televisions, and so on.

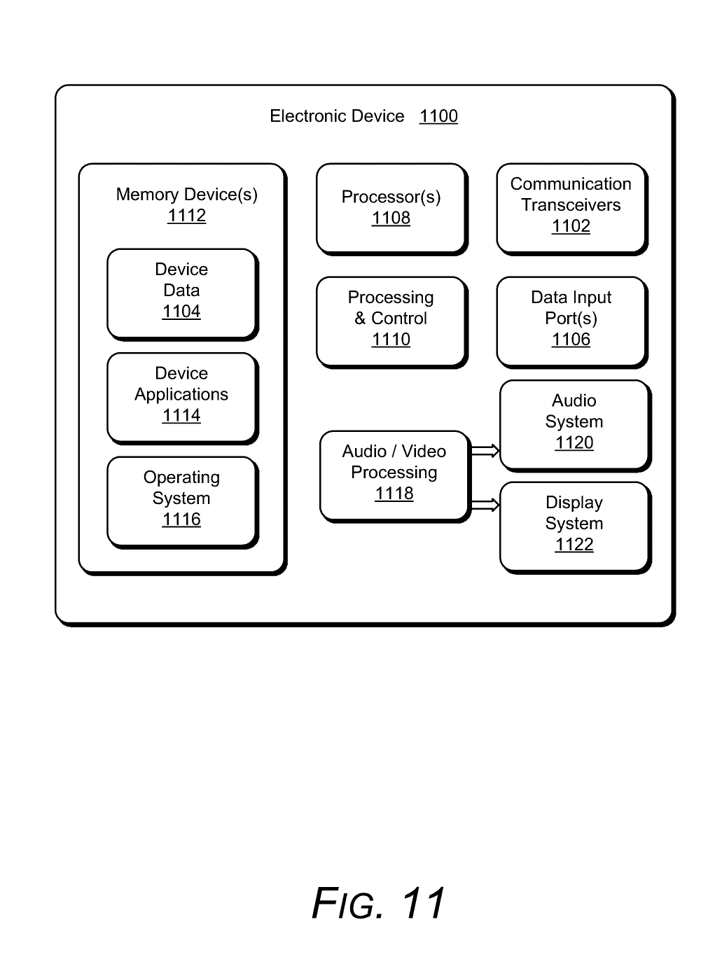

Thus, the computing device 102 ranges from full resource devices with substantial memory and processor resources (e.g., personal computers, game consoles) to low-resource devices with limited memory and/or processing resources (e.g., wearables or other device as part of the Internet-of-things). Although single instances of computing devices are illustrated as examples, a computing device may be representative of a plurality of different devices (e.g., a television and remote control) as further described in relation to FIG. 11.

The computing device 102, regardless of configuration, is configured to include a three dimensional (3D) object detection system 118 and a gesture module 120 that are implemented at least partially in hardware. The gesture module 120 is representative of functionality to identify gestures made by a user 122 (e.g., either directly by the user and/or with an object) to initiate operations performed by the computing device 102. For example, the gesture module 120 may receive inputs that are usable to detect attributes to identify an object, orientation of the object, and/or movement of the object. Based on recognition of a combination of one or more of the attributes, the gesture module 120 may cause an operation to be performed, such as to detect a rightward swipe by a user's hand and cause a user interface output by the computing device 102 to move a corresponding direction.

The 3D object detection system 118 is configurable to detect objects in three dimensions, such as to identify the object, an orientation of the object, and/or movement of the object. Detection may be performed using a variety of different techniques, such as cameras (e.g., a time-of-flight camera), sound waves, and so on. In the illustrated example, the 3D object detection system 118 is configured to use radar techniques and radio waves through use of a radio wave transmitter/receiver 124 and a radar processing module 126. The radio wave transmitter/receiver 124, for instance, transmits radio waves in the radio frequency range corresponding to one or more Wi-Fi frequency bands, e.g., IEEE 802.11 and so forth. The radar processing module 126 then detects return of these radio waves to detect objects, which may be performed at a resolution of less than one centimeter.

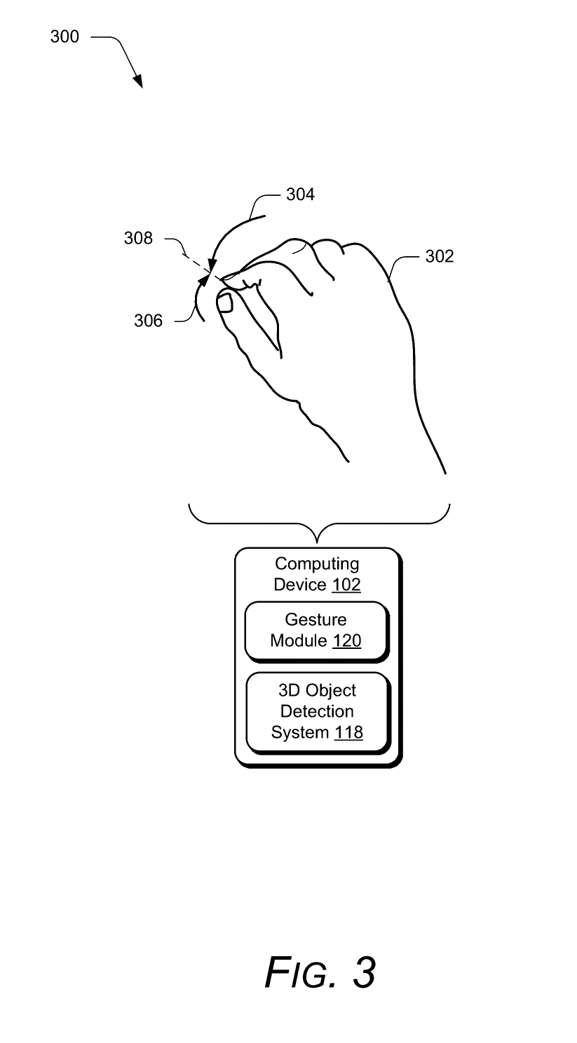

Movement is detected with increased accuracy when using radio waves, especially when detecting differences in movement by different body parts of a user 122. For example, the detected return of these radio waves may be used to readily differentiate between fingers of a user's hand when moving in different directions. The detected differences in direction provide increased accuracy over single movements or no movements at all. However, the radar processing techniques described herein are capable of detecting each of the instances. A variety of other examples of differences in bodily movement are also contemplated as further described in relation to FIGS. 3-8.

Through use of radio waves, the 3D object detection system 118 may also detect objects that are located behind other objects, e.g., are least partially obscured from “view” by another object. The 3D object detection system 118 may also transmit through materials such as fabric and plastics and even through a housing of the computing device 102 itself such that the housing may be made with lower cost and increased protection against outside elements.

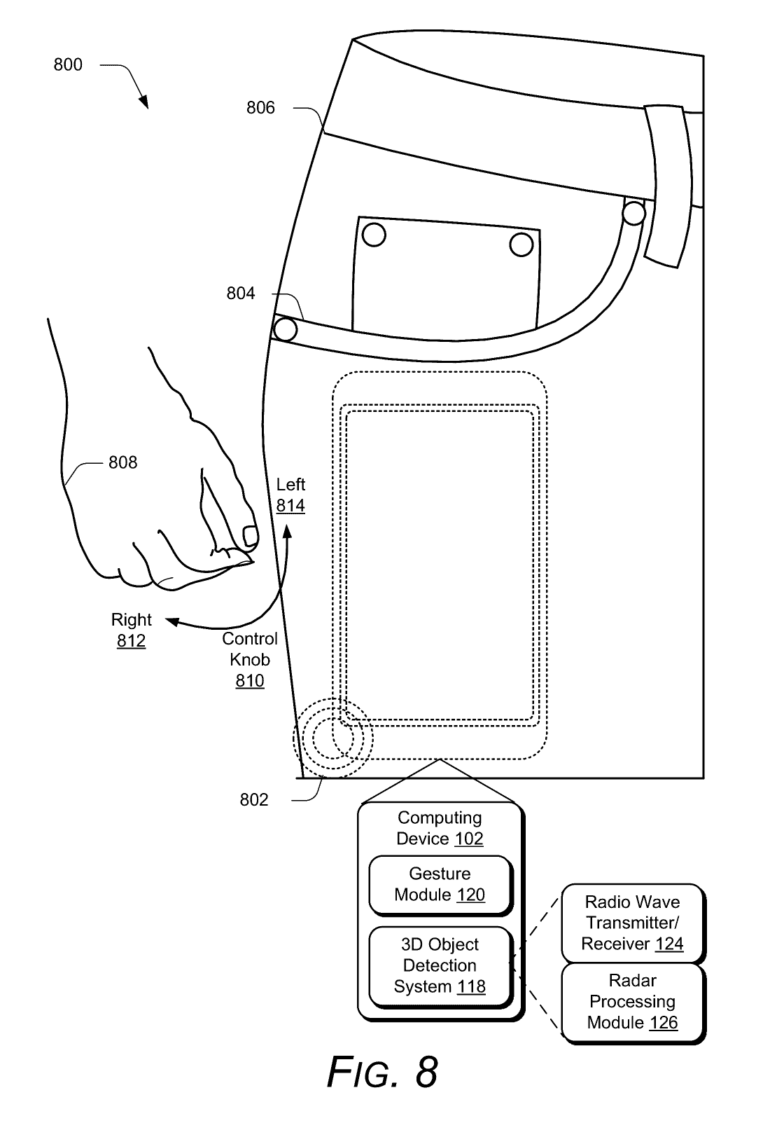

These techniques may also be leveraged to detect gestures while the computing device 102 is the user's 122 pocket as further described in relation to FIG. 8. Complementary detection techniques may also be used, such as for the radar processing module 126 to leverage inputs from a plurality of computing devices, such as a watch and phone as illustrated, to detect as a gesture. In the following, a variety of gesture detection and interaction techniques are described, which may be implemented using radar or other object detection techniques.

FIG. 2 depicts a procedure 200 and FIG. 3 depicts a system 300 in an example implementation in which inputs involving movement of body parts of a user that impart haptic feedback to the user are used to initiate operations of the computing device. In the following, reference is made interchangeably to both FIGS. 2 and 3.

The following discussion describes techniques that may be implemented utilizing the previously described systems and devices. Aspects of the procedure may be implemented in hardware, firmware, or software, or a combination thereof. The procedure is shown as a set of blocks that specify operations performed by one or more devices and are not necessarily limited to the orders shown for performing the operations by the respective blocks.

Inputs are detected that involve movement in three-dimensional space of body parts of a user in relation to each other. The movement imparts haptic feedback back to the user through contact of the body parts, one to another (block 202). Movement of a user's hand 302, for instance, may be detected by the 3D object detection system 118. The movement involves movement of an index finger 304 and movement of a thumb 306 to achieve contact 308. As illustrated, this movement results in a pinch that is made in three-dimensional space by the user that is free of contact with the computing device 102. Rather, the contact 308 occurs between the body parts of the user, e.g., the index finger and thumb. Accordingly, the contact 308 of the movements of the index finger and thumb 304, 306 provides haptic feedback to the user by leveraging the body of the user as part of the detected movement.

A gesture is recognized from the detected inputs (block 204) and performance is controlled of one or more operations of the computing device that correspond to the recognized gesture (block 206). The gesture module 120, for instance, may receive the inputs from the 3D object detection system 118. From these inputs, the gesture module 120 detects movements of the body parts in relation to each other, e.g., the “pinch” being performed. The gesture module 120 initiates an operation of the computing device 102 based on the detected movements, such as to select an item displayed by a display device of the computing device 102 in a user interface.

In this way, contact of body parts of a user, one to another, provides haptic feedback as part of making the movements. Further, the movements are detectable by the computing device 102 as a gesture to initiate operations of the computing device 102. Thus, the user is provided with feedback as part of interaction with the computing device 102 without physically contacting the computing device 102 or having related devices provide this contact, e.g., through use of focused ultrasound. In this example, the contact is involved in making the movements that are recognized by the computing device 102 as the gesture. These movements may also be defined as part of the gesture, an example of which is described in the following and shown in a corresponding figure.

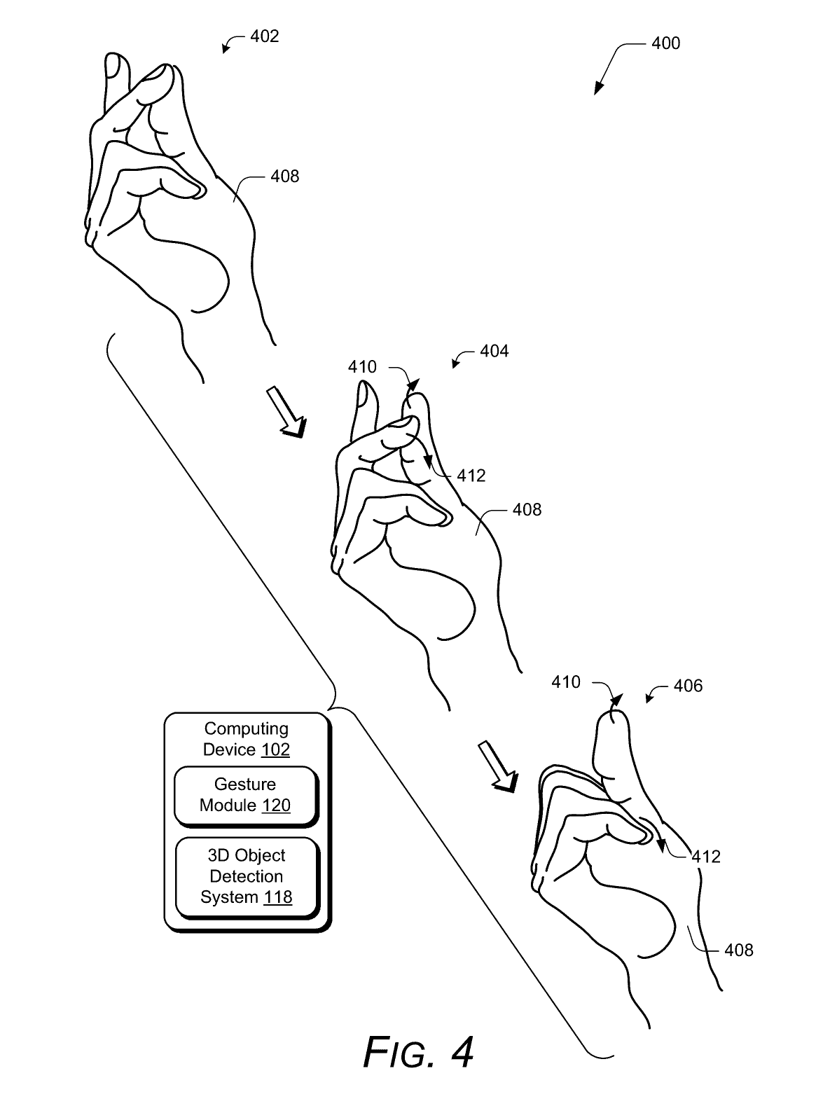

FIG. 4 depicts an example implementation 400 of gesture detection haptics in which detection of contact is included as a basis of gesture recognition. This example is illustrated using first, second, and third stages 402, 404, 406 to show successive movements of body parts of a user. At the first stage 402, a middle finger and thumb are in contact with each other. At the second stage 402, the middle finger and thumb move 410, 412 against each other while still maintaining contact, i.e., as part of a sliding motion such as in a virtual trackpad example above. This movement 410, 412 continues to the third stage 406, at which it stops. Thus, in this example the movement 410, 412 makes a snapping motion using the middle finger and thumb of the user's hand 408.

The gesture module 120 processes inputs that describe this motion and contact in this example. For example, the inputs detected by the gesture module 120 detect contact at the first stage 402, sliding movement at the second stage 404, and movement away from each other (i.e., the fingers) in space at the third stage 406. From this, the gesture module 120 determines that this movement meets the definition of a snap gesture and initiates an operation that corresponds to this gesture, e.g., turn off the lights. Accordingly, the contact is included along with the movement in this example to define the gesture and cause a corresponding operation to be performed.

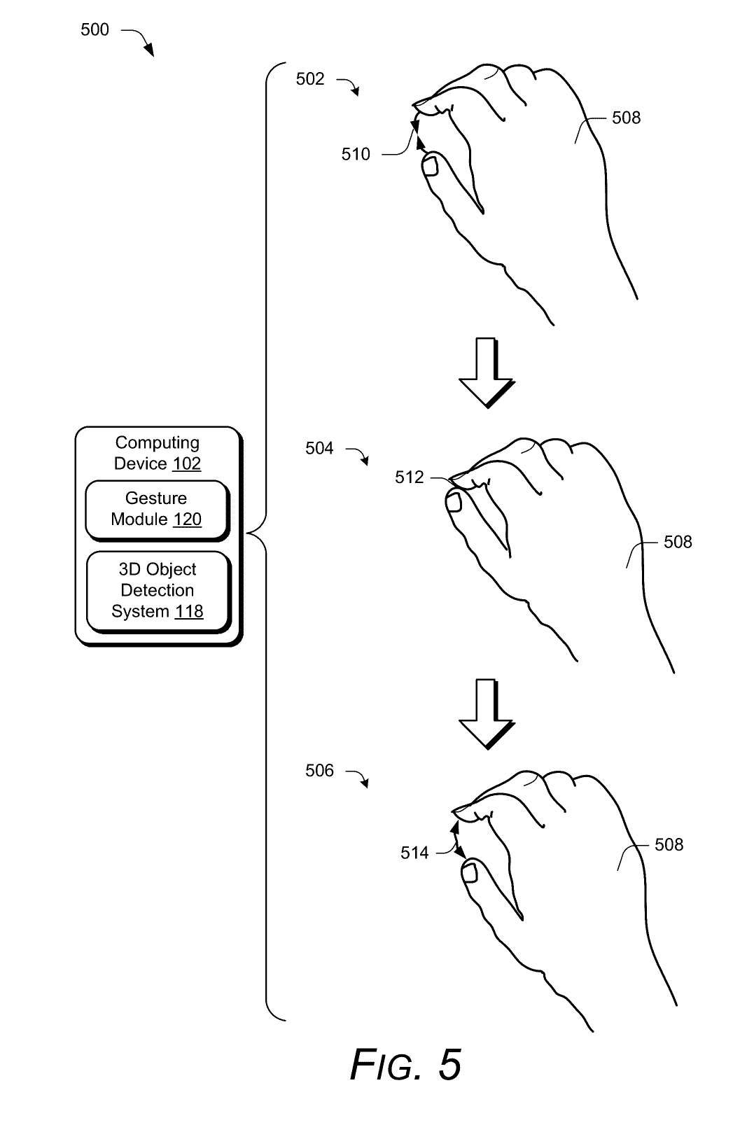

FIG. 5 depicts an example implementation 500 of gesture detection haptics in which detection of contact is included as a basis of gesture recognition to define when a corresponding operation is to be initiated. This example is also illustrated through the use of first, second, and third stages 502, 504, 506. In the previous example, the contact is included as part of the movement to help form the definition as to how the gesture is recognized. In this example, the contact also specifies a point of time, at which, the operation is to be initiated.

At the first stage 502, for instance, a user's hand 508 is shown moving 510 an index finger and thumb toward each other, with contact 512 reached at the second stage 504. The gesture module 120 detects this contact through inputs received from the 3D object detection system 118. For example, the inputs may describe the movement 510 which then stops at a point of contact 512. In another example, the movement 510 may indicate that corresponding objects have moved toward each other and likely collided based on relative positioning in three-dimensional space. A variety of other examples of detection of contact are also contemplated, such as a radar return indicating that the objects touch.

In response to detection of the contact, the gesture module 120 initiates an operation corresponding to the gesture. Thus, the contact defines when an operation corresponding to the gesture is to be initiated. This mechanism may also be used to initiate another operation that is to be performed as part the gesture, such as to define this other operation when movement 514 is detected that releases the contact 512, as shown at the third stage 506.

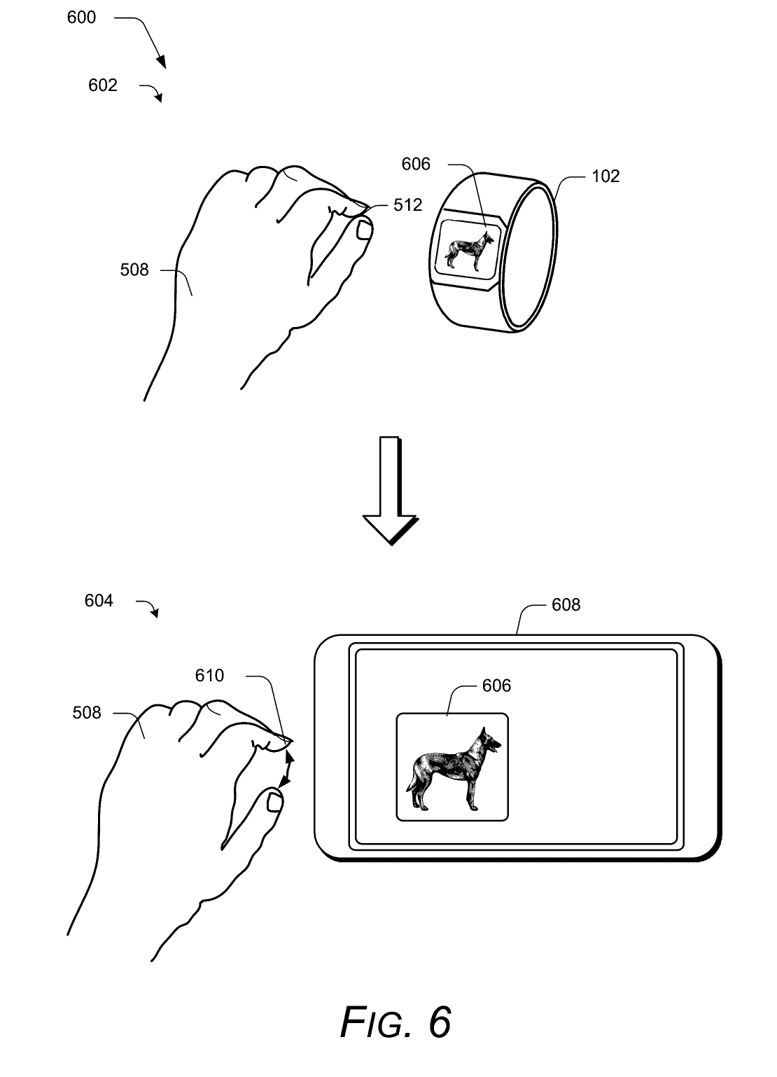

FIG. 6 depicts an example implementation 600 of selection of an object in a user interface through use of the gesture of FIG. 5. This implementation 600 is illustrated using first and second stages 602, 604. At the first stage 602, the user's hand 508 is illustrated as having an index finger and thumb make contact 512 as part of a pinch gesture as described in relation to FIG. 5.

The contact in this example is made as part of a pinch gesture. The operation that corresponds to the pinch gesture is used to select an object 606 display by a user interface of the computing device 102. The user then maintains this pinch and moves proximal to another computing device 608 as illustrated as the second stage 604. The user then moves the index finger and thumb apart thereby releasing the contact. This release of the contact is recognized by the other computing device 608 to transfer object 606 to the other computing device 608. Thus, the contact 512 in this example is used to both define an operation as to when the object is selected and when to release the object, e.g., as part of a select-and-drag operation between devices. A variety of other examples are also contemplated as further described in the following.

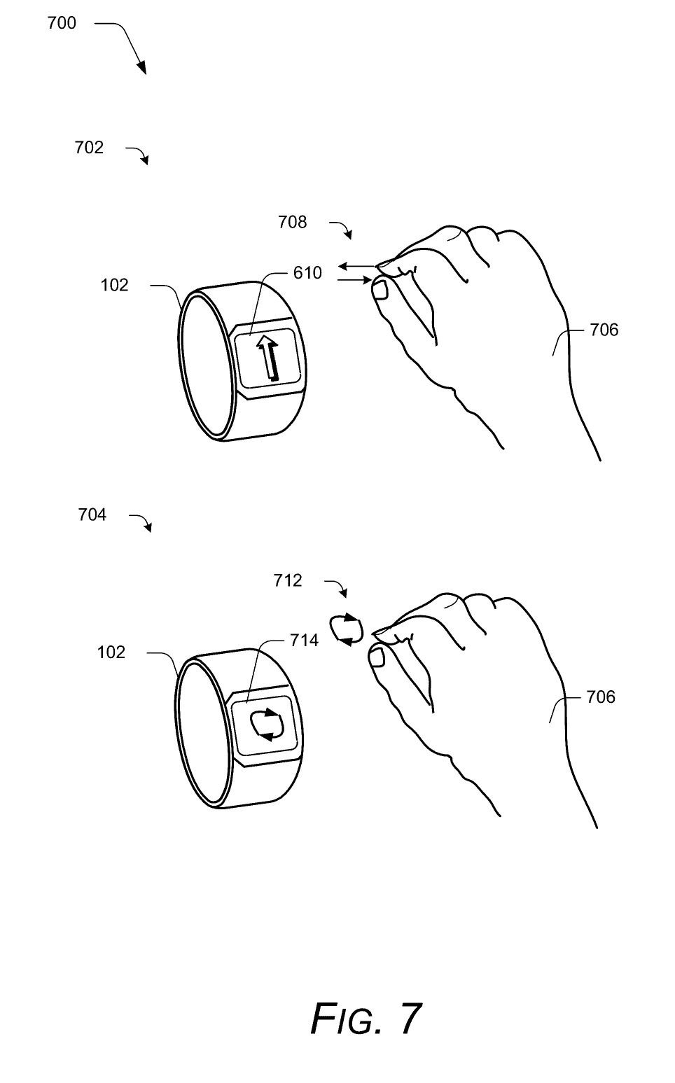

FIG. 7 depicts an example implementation 700 in which additional examples of movements and contact to impart haptics are shown. First and second examples 702, 704 are illustrated. In the first example 702, fingers of a user's hand are illustrated as making a movement 708 involving contact and planar movement. This is caused to initiate an operation to navigate vertically in a user interface 710, although other operations are also contemplated.

In the second example 704, fingers of the user's hand contact and move 712 rotationally, one to another, in a manner that mimics the winding of a watch. This movement is recognized by the computing device 102 as a gesture to cause rotation 714 of an object in a user interface. A plurality of other examples of motions involving contact to impart haptic feedback as part of a gesture to initiate operations of a computing device are also contemplated, include contact that includes three or more body parts of a user (e.g., multi-handed gestures), gestures that involve bodily parts other that the hand (e.g., a face palm), and so forth.

The 3D object detection system 118 and gesture module 120 may also be configured to detect where, in relation to a sensor (e.g., the radio wave transmitter/receiver 124) the movement is performed. From this, different gestures may be recognized even though the movements are the same. For example, first and second gesture fields may be defined for a side of a wearable computing device 102. When the rotational movement 712 is detected near the side, horizontal scrolling gestures, tab navigation, and so on may be detected. When the rotational movement 712 is detected near a surface of the display device, different gestures are recognized, such as vertical scrolling, row selection, and so forth. Visual feedback may also be provided by the computing device 102 to provide feedback regarding a current detection zone, in which, body parts of the user are currently positioned. Other examples of zones are also contemplated, which may be based on differences in distance as opposed to or in addition to differences in location, differences in orientation in three-dimensional space, and so forth.

FIG. 8 depicts a system 800 in an example implementation in which a gesture is detected through an article associated with or worn by a user. As previously described, the 3D object detection system 118 is configurable in a variety of ways to detect gestures. An example of this is radar techniques performed using a radio wave transmitter/receiver 124 and a radar processing module 126. The radio wave transmitter/receiver 124, for instance, may transmit radio waves 802 using one or more frequencies that fall within a Wi-Fi frequency band, e.g., in compliance with one or more IEEE 802.11 or other standards. In this example, these radio waves 1102 are of a sufficient strength to pass through fabric or plastic, such as an article worn by (e.g., shirt, pants) or associated with (e.g., a purse, brief case, gym bag, backpack) a user.

In the illustrated instance, the computing device 102 is placed within a front pocket 804 of jeans 806 worn by a user 122 of FIG. 1. The 3D object detection system 118 detects an object in three dimensional space through an article worn by or associated with a user. The 3D object detection system 118, for instance, uses radar techniques involving radio waves 802 that pass through the article of clothing to identify and detect movement of an object, such as a hand 808 of a user.

The gesture module 120 then causes performance of one or more operations by the computing device responsive to the identification of gestures from inputs involving the detection. The computing device 102, for instance, may be configured as a mobile phone and when the user receives a call, the user may initiate a gesture to silence the phone without even physically touching the phone or removing it from the user's pocket. In another example, gestures may be made to navigate through music being transmitted to wireless headphones by making gestures to navigate forward or back through a playlist. Although described as a mobile phone in this example, these techniques are also applicable to wearable devices such as those having a housing configured to be worn by a user, such that interaction with the device may be supported without requiring the user to actually view or expose the device.

The movements may also be configured to mimic interaction with a virtual tool. For example, movements of the fingers of the hand of the user 808 may mimic interaction with a virtual tool, such as a control knob 810. A variety of operations may be associated with this virtual control, such as to navigate through a playlist, adjust volume, and so forth by rotating the fingers of the hand 808 having contact right 812 or left 814. In this way, the user is provided a metaphor for interaction with the computing device 102, further discussion of which is included in the following.

FIG. 9 depicts a procedure 900 and FIG. 10 depicts a system 1000 in an example implementation in which movements that mimic existence and control of a virtual too are used to control operations of a computing device 102. FIG. 10 is illustrated using first, second, third, fourth, and fifth examples 1002, 1004, 1006, 1008, 1010. In the following, reference is made interchangeably to both FIGS. 9 and 10.

The following discussion describes techniques that may be implemented utilizing the previously described systems and devices. Aspects of the procedure may be implemented in hardware, firmware, or software, or a combination thereof. The procedure is shown as a set of blocks that specify operations performed by one or more devices and are not necessarily limited to the orders shown for performing the operations by the respective blocks.

Inputs are detected that involve user movement in three-dimensional space as both mimicking existence of a virtual tool and operation of the virtual tool (block 902). The computing device 102 of FIG. 1, for instance, may employ the 3D object detection system 118 to detect movements of body parts of a user that mimic grasping of a particular tool, such as a tool have a pistol grip, tubular handle (e.g., a hammer, screwdriver), and so forth. This may also include use of contact as previously described.

The virtual tool is identified from the detected inputs (block 904). For example, inputs mimicking the grasping of a tubular handle may be used to identify a virtual screwdriver by the computing device 102. Additionally, a gesture is recognized from the detected inputs corresponding to the virtual tool (block 906). Continuing with the previous example, after making the motion that mimics grasping of the handle, the user may a rotational motion that mimics use of the virtual screwdriver. From this, performance of one or more operations are controlled of the computing device that correspond to the identified virtual tool (block 908), such as to rotate an item in a user interface, control motion of a robot or drone, and so forth. In this way, gestures involving virtual tools are leveraged to identify availability of the gesture, how to perform the gesture, and also what operations is being performed by the computing device through use of the gesture. Examples of such gestures are described in the following.

In a first example 1002, a user's hand mimics grasping a handle of a hammer and making a motion 1014 that mimics swinging the hammer. The hammer, however, is virtual and thus does not physically exist. From the motion of grasping the handle and subsequent movement 1014 as an arc the computing device 102 identifies the virtual tool and the gesture performed using the tool. A corresponding operation is then initiated by the computing device 102, e.g., as part of a video game.

In the second example 1004, the user's hand 1012 mimics grasping a pistol grip of a virtual drill, e.g., with a finger mimicking operation of a button of the drill. A motion 1016 is also detected involving movement 1016 of the drill. Thus, the motion of grasping the pistol grip of the drill and subsequent movement 1016 of the drill is used to identify the virtual tool and corresponding gesture. In the third example 1006, a user makes a motion that mimics grasping a cord of a plug and then a motion 1018 involving insertion of the plug into a socket.

Motions may also be used to differentiate between different virtual tools. In the fourth example 1008, for instance, the hand 1012 of the user makes a motion mimicking grasping of a handle of a screwdriver. Subsequent rotational movement 1020 is then detected about a longitudinal axis of the virtual tool, e.g., a twisting motion. From this, the computing device 102 identifies both the virtual tool and the gesture performed using the tool, e.g., a virtual screwdriver. In the fifth example, however, the user's hand 1012 makes a similar motion mimicking grasping of a handle. However, the motion 1022 in this example, although rotational, is rotational along a plane in three-dimensional space that coincides with the longitudinal axis of the tool. From this, the computing device 102 also identifies the virtual tool “wrench” and corresponding gesture, which is differentiated from the screwdriver virtual gesture. A variety of other examples of virtual tools and corresponding gestures are also contemplated, such as a dial, screwdriver, hammer, tongs, power tool, or wipe.

Example Electronic Device

FIG. 11 illustrates various components of an example electronic device 1100 that can be implemented as a wearable haptic and touch communication device, a wearable haptic device, a non-wearable computing device having a touch-sensitive display, and/or a remote computing device as described with reference to any of the previous FIGS. 1-10. The device 1110 may include the 3D object detection system 118 and gesture module 120 implemented in whole or in part using the following described functionality. The device may be implemented as one or combination of a fixed or mobile device, in any form of a consumer, computer, portable, user, communication, phone, navigation, gaming, audio, messaging, Web browsing, paging, media playback, and/or other type of electronic device, such as the wearable device 104 described with reference to FIG. 1.

Electronic device 1100 includes communication transceivers 1102 that enable wired and/or wireless communication of device data 1104 and may also support the radar techniques previously described. Other example communication transceivers include NFC transceivers, WPAN radios compliant with various IEEE 802.15 (Bluetooth™) standards, WLAN radios compliant with any of the various IEEE 802.11 (WiFi™) standards, WWAN (3GPP-compliant) radios for cellular telephony, wireless metropolitan area network (WMAN) radios compliant with various IEEE 802.11 (WiMAX™) standards, and wired local area network (LAN) Ethernet transceivers.

Electronic device 1100 may also include one or more data input ports 1116 via which any type of data, media content, and/or inputs can be received, such as user-selectable inputs, messages, music, television content, recorded video content, and any other type of audio, video, and/or image data received from any content and/or data source. Data input ports 1116 include USB ports, coaxial cable ports, and other serial or parallel connectors (including internal connectors) for flash memory, DVDs, CDs, and the like. These data input ports may be used to couple the electronic device to components, peripherals, or accessories such as keyboards, microphones, or cameras.

Electronic device 1100 of this example includes processor system 1108 (e.g., any of application processors, microprocessors, digital-signal-processors, controllers, and the like), or a processor and memory system (e.g., implemented in a SoC), which process (i.e., execute) computer-executable instructions to control operation of the device. Processor system 1108 (processor(s) 1108) may be implemented as an application processor, embedded controller, microcontroller, and the like. A processing system may be implemented at least partially in hardware, which can include components of an integrated circuit or on-chip system, digital-signal processor (DSP), application-specific integrated circuit (ASIC), field-programmable gate array (FPGA), a complex programmable logic device (CPLD), and other implementations in silicon and/or other hardware. Alternatively or in addition, the electronic device can be implemented with any one or combination of software, hardware, firmware, or fixed logic circuitry that is implemented in connection with processing and control circuits, which are generally identified at 1110 (processing and control 1110). Although not shown, electronic device 1100 can include a system bus, crossbar, or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Electronic device 1100 also includes one or more memory devices 1112 that enable data storage, examples of which include random access memory (RAM), non-volatile memory (e.g., read-only memory (ROM), flash memory, EPROM, EEPROM, etc.), and a disk storage device. Memory device(s) 1112 provide data storage mechanisms to store the device data 1104, other types of information and/or data, and various device applications 1114 (e.g., software applications). For example, operating system 1116 can be maintained as software instructions within memory device 1112 and executed by processors 1108.

Electronic device 1100 also includes audio and/or video processing system 1118 that processes audio data and/or passes through the audio and video data to audio system 1120 and/or to display system 1122 (e.g., spectacles, displays on computing bracelet as shown in FIG. 1, and so on) to output content 118. Audio system 1120 and/or display system 1122 may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link. In some implementations, audio system 1120 and/or display system 1122 are external components to electronic device 1100. Alternatively or additionally, display system 1122 can be an integrated component of the example electronic device, such as part of an integrated touch interface.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method of controlling operation of a computing device based on gesture detection, the method comprising:
detecting, by the computing device, inputs involving movement in three-dimensional space of body parts of a user in relation to each other, the movement imparting haptic feedback to the user through contact of the body parts, one to another;
recognizing, by the computing device, a gesture from the detected inputs; and
controlling, by the computing device, performance of one or more operations of the computing device that correspond to the recognized gesture.

2. The method as described in claim 1, wherein the detecting is performed using a three dimensional object detection system of the computing device that performs the detecting using radar techniques involving radio waves.

3. The method as described in claim 2, wherein the radio waves correspond to a frequency band included as part of a Wi-Fi radio spectrum.

4. The method as described in claim 1, wherein the detecting of the contact of the body parts specifies initiation of the one or more operations of the gesture.

5. The method as described in claim 4, wherein the detecting of release of the contact of the body parts specifies cessation of the one or more operations of the gesture.

6. The method as described in claim 1, wherein the movement of the body parts includes rotational movement of appendages of the user in relation to each other.

7. The method as described in claim 1, wherein the movement of the body parts includes pressing of an appendage of the user against another said body part of the user.

8. A method of controlling operation of a computing device based on gesture detection, the method comprising:
detecting, by the computing device, inputs involving user movement in three-dimensional space as both mimicking existence of a virtual tool and operation of the virtual tool;
identifying, by the computing device, the virtual tool from the detected inputs;
recognizing, by the computing device, a gesture from the detected inputs corresponding to the virtual tool; and
controlling, by the computing device, performance of one or more operations of the computing device that correspond to the identified virtual tool.

9. The method as described in claim 8, wherein the virtual tool mimics a size and shape of physical tool configured for interaction by a hand of the user.

10. The method as described in claim 8, wherein the virtual tool mimics a dial, screwdriver, hammer, tongs, power tool, or wipe.

11. The method as described in claim 8, wherein the existence of a virtual tool and the operation of the virtual tool are identified and recognized from the detected inputs as involving movement in three-dimensional space of body parts of a user in relation to each other.

12. The method as described in claim 8, wherein the detecting is performed using a three-dimensional object detection system configured to generate the inputs using radio waves.

13. The method as described in claim 12, wherein the radio waves correspond to a frequency band included as part of a Wi-Fi radio spectrum.

14. A system comprising:
a three-dimensional object detection system implemented at least partially in hardware of a computing device to detect inputs involving movement in three-dimensional space of body parts of a user in relation to each other, the movement imparting haptic feedback to the user through contact of the body parts, one to another; and
a gesture module implemented at least partially in hardware of the computing device to recognize a gesture from the detected inputs and control performance of one or more operations of the computing device that correspond to the recognized gesture.

15. The system as described in claim 14, wherein the three-dimensional object detection system is configured to detect the inputs using radio waves.

16. The system as described in claim 15, wherein the radio waves correspond to a frequency band included as part of a Wi-Fi radio spectrum.

17. The system as described in claim 14, wherein the three-dimensional object detection system is configured to detect the inputs through an article of clothing worn by the user.

18. The system as described in claim 14, further comprising a housing having the three-dimensional object detection system and the gesture module disposed therein.

19. The system as described in claim 18, wherein the housing is configured to be worn or carried by a user.

20. The system as described in claim 18, wherein the housing is part of an automobile, television, or desktop computer.
